(19) United States
(12) Patent Application Publication
(10) Pub. No.: US 2008/0124049 A1
(43) Pub. Date: May 29, 2008

(54) METHOD FOR ELIMINATING NOISE OF A MOTOR

(76) Inventors: Chan-Min Chou, Hsinchu City (TW); Peng-Wei Lin, Hsinchu City (TW); Shih-Chang Han, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/673,051

(22) Filed: Feb. 9, 2007

(30) Foreign Application Priority Data
Sep. 21, 2006 (TW) 095135027

(51) Int. Cl. H04N 5/911; H04N 5/21

(52) U.S. Cl. 386/102; 348/241; 348/240.99; 386/E05.003

(57) ABSTRACT

The method is used to eliminate the sound of a motor when a digital image capturing device is recording. The method includes the steps of: inputting a simulated control signal; simulating a motor operational status and recording a simulated sound wave of the motor to establish a simulated sound wave database; and eliminating the noise of the motor in the dynamic film by the use of the simulated sound wave when the digital image capturing device is recording.

### BACKGROUND OF THE INVENTION

1. Field of the Invention

The present invention relates to a method for eliminating noise of a motor, more particularly, to a method for eliminating noise of a motor by creating a simulated sound wave.

2. Description of the Related Art

The ability to record images is an important feature of digital image capturing devices; users often use a digital image capturing device to record dynamic images. When a user is recording images, he or she often needs to adjust the focus or the zoom of the lens by rotating a motor. During the adjustment process, the noise caused by the rotation of the motor in the digital image capturing device may also be recorded, affecting the quality of recording.

In the prior art technology, in order to solve the above-mentioned problem, a unidirectional microphone or an external microphone is typically utilized to avoid recording the noise of the motor. However, if a unidirectional microphone is to be used, a special layout design, which might increase the complexity of the device, will be inevitable to the digital image capturing device. In contrast, if an external microphone is to be used, users will have to hold the external microphone when they are using the digital image capturing device, which can be a lot of trouble for them; furthermore, noise might be included during the recording, or the volume recorded might fluctuate if the external microphone is shaken.

Another known method to fix the problem is to stop any lens adjustment during filming. However, this method is very restrictive for the user, and so is even more inconvenient. Still another known method is to replace a standard motor with a silent motor in a digital image capturing device; however, since silent motors are more expensive, the replacement will increase the costs of digital image capturing devices.

It is therefore desirable to provide a method for eliminating the noise of a motor that mitigates and/or obviates the aforementioned problems.

### SUMMARY OF THE INVENTION

A main objective of the present invention is to provide a method for eliminating the noise of a motor.

The digital image capturing device of the present invention can be a digital still camera or a digital video camera. The digital image capturing device comprises a processor, a motor, a memory, and a microphone. In the digital image capturing device, the processor is used to control the motor, the memory, and the microphone. In addition, the memory stores a simulated sound wave database for eliminating the noise of the motor.

The method of the present invention needs to establish a simulated sound wave database by the following steps:

inputting at least one simulated control signal to simulate different operational statuses of the motor;

enabling the motor to perform each operational status, such as clockwise rotation, anti-clockwise rotation, or change of rotation rate, in accordance with the simulated signal;

recording an operating sound of the motor by the use of a microphone to obtain a simulated sound wave;

and storing the simulated sound wave in the memory to establish a simulated sound wave database.

When the user is recording with the digital image capturing device, he or she can press associated buttons to adjust the focus or the zoom of the lens. Subsequently, the processor receives the control signals sent by the buttons. The processor needs to read the corresponding simulated sound of the motor from the simulated sound wave database stored in the memory before controlling the motor. When the motor is controlled by the processor, an out-of-phase simulated sound wave will be added so as to eliminate the noise of the motor.

Other objects, advantages, and novel features of the invention will become more apparent from the following detailed description when taken in conjunction with the accompanying drawings.

### BRIEF DESCRIPTION OF THE DRAWINGS

FIG. 1 is a function block drawing of a digital image capturing device according to the present invention.

FIG. 2 is a flowchart of creating a simulated sound wave database according to the present invention.

FIG. 3 is a flowchart of eliminating the noise of a motor according to the present invention.

### DETAILED DESCRIPTION OF THE PREFERRED EMBODIMENT

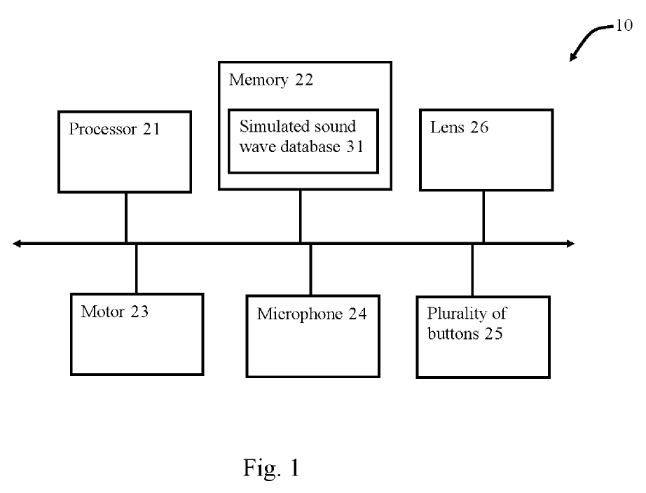

Please refer to FIG. 1, a function block drawing of a digital image capturing device 10 according to the present invention.

The digital image capturing device 10 of the present invention comprises a processor 21, a memory 22, a motor 23, a microphone 24, a plurality of buttons 25 and a lens 26, all of which are electrically connected to each other. The digital image capturing device 10 may be, but is not limited to, a digital still camera or a digital video camera. The processor 21 is used for controlling the memory 22, the motor 23, the microphone 24, and the lens 26. The memory 22 may be a NAND flash memory, but other types of memory are also possible. The memory 22 is used for storing necessary application programs and a simulated sound wave database 31. The simulated sound wave database 31 is used for eliminating the noise generated during the operation of the motor 23. The method for establishing the simulated sound wave database 31 and eliminating the noise of the motor 23 is described later. When the digital image capturing device 10 begins recording, the lens 26 is used to obtain images, and the motor 23 may be used to change the focus or the zoom of the lens 26. The microphone 24 is used for receiving audio when the digital image capturing device 10 is recording. The plurality of buttons 25 comprises, but is not limited to, buttons for taking pictures, recording video, or adjusting the focus or the zoom of the lens 26. Users can control the digital image capturing device 10 by the use of the plurality of buttons 25.

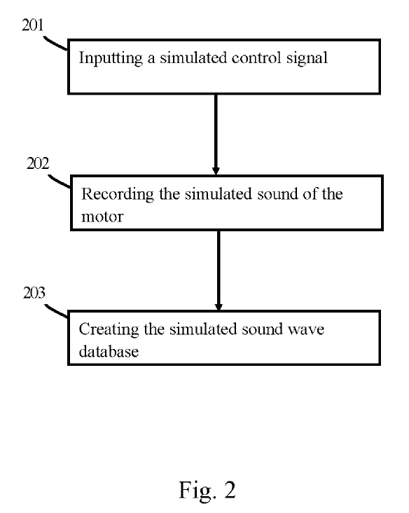

Before the digital image capturing device 10 begins recording, the simulated sound wave database 31 should be created. Please refer to FIG. 2, a flowchart of creating a simulated sound wave database according to the present invention.

First, the present invention proceeds with step 201: inputting a simulated control signal.

In addition, the present invention also performs a simulation procedure whose environment is the same as the actual operating environment. In other words, the actual digital image capturing device 10, with its motor 23 and the microphone 24, are utilized when performing the simulation procedure. The simulated control signal should be input first to simulate various functions performed by the motor 23 which are needed by the digital image capturing device 10, such as adjusting the focus or the zoom of the lens 26. The motor 23 may perform clockwise rotation, anti-clockwise rotation, or change of rotation rate in accordance with the simulated signal.

Next, the present invention proceeds with step 202: recording the simulated sound of the motor 23.

The simulated sounds of the motor 23 under different operating conditions are recorded by the microphone 24, and the wave of each simulated sound is stored in the memory 22. The simulated sound waves may be stored in the form of a non-compressed sound wave, such as a pulse code modulation (PCM) format. Alternatively, in order to save the capacity within the memory 22, only a sectioned sound wave, a volume altitude of the simulated sound, and a main frequency of the simulated sound are stored. Any of the various, suitable storage methods may be used for the present invention.

Finally, the present invention proceeds with step 203: creating the simulated sound wave database 31.

All simulated sound waves of the motor 23 are stored in the memory 22, and the simulated sound wave database 31 is thereby created.

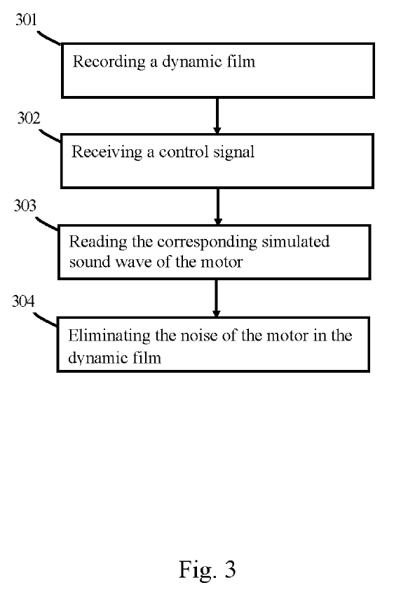

After the simulated sound wave database 31 is created, it can be used to eliminate the operating noise generated by the motor 23. Please refer to FIG. 3, a flowchart of eliminating the noise of the motor 23 according to the present invention.

First, the present invention proceeds with step 301: recording a dynamic film.

When a user operates the digital image capturing device 10 and presses the “record” button in the plurality of buttons 25, the digital image capturing device 10 will begin to record a dynamic film, and the microphone 24 will begin to record the audio of the dynamic film.

Next, the present invention proceeds with step 302: receiving a control signal.

When the user is recording, he or she can press associated buttons in the plurality of buttons 25 to adjust the focus or the zoom of the lens 26. Subsequently, the processor 21 receives the control signals sent by the associated buttons.

After that, the present invention proceeds with step 303: reading the corresponding simulated sound of the motor 23.

After the processor 21 receives the control signals, it has to read the corresponding simulated sound wave of the motor 23 from the simulated sound wave database 31 stored in the memory 22 before controlling the motor 23. Since the simulated sound wave database 31 includes the simulated sound waves of the motor 23 under all possible operational conditions, every control signal has its corresponding simulated sound wave of the motor 23.

Finally, the present invention proceeds with step 304: eliminating the noise of the motor 23 in the dynamic film.

While the processor 21 controls the operation of the motor 23, the processor 21 also adds an out-of-phase simulated sound wave of the motor 23. By the use of the fully destructive interference provided by wave theory, the operating noise of the motor 23 recorded by the microphone 24 is eliminated by the out-of-phase simulated sound wave of the motor 23. Therefore, while the digital image capturing device 10 is recording the dynamic film, no operating sounds or noises of the motor 23 are present in the dynamic film.

Although the present invention has been explained in relation to its preferred embodiments, it is to be understood that many other possible modifications and variations can be made without departing from the spirit and the scope of the invention as hereinafter claimed.

What is claimed is:

1. A method for eliminating noise of a motor in a digital image capturing device, the method comprising:
establishing an simulated sound wave database by the following steps:
inputting at least one simulated control signal to control an operational status of the motor; and
recording an operating sound of the motor to obtain a simulated sound wave;
recording a dynamic film;
receiving a control signal and controlling the operational status of the motor by the control signal;
reading a simulated sound wave corresponding to the control signal from the simulated sound wave database; and
eliminating the noise of the motor in the dynamic film by the use of the simulated sound wave.

2. The method as claimed in claim 1, wherein the operational status of the motor comprises clockwise rotation, anti-clockwise rotation, or change of rotation rate.

3. The method as claimed in claim 1, further comprising a step of using a microphone to record the simulated sound of the motor.

4. The method as claimed in claim 3, further comprising a step of using the microphone to record a sound of the dynamic film.

5. The method as claimed in claim 1, wherein the simulated sound wave is a non-compressed sound wave.

6. The method as claimed in claim 1, wherein the simulated sound wave is a sectioned sound wave.

7. The method as claimed in claim 6, further comprising a step of obtaining a volume altitude and a sound frequency of the sectioned sound wave.

8. A digital image capturing device, comprising:
a processor;
a memory, which is electrically connected to the processor, for storing a simulated sound wave database comprising at least one simulated sound wave; and
a motor electrically connected to the processor,
wherein the processor is capable of controlling the memory and the motor to achieve the following mechanisms while recording an dynamic film:
receiving a control signal and controlling an operational status of the motor by the control signal;
reading a simulated sound wave corresponding to the control signal from the simulated sound wave database; and
eliminating the noise of the motor in the dynamic film by the use of the simulated sound wave.

9. The digital image capturing device as claimed in claim 8, wherein the motor is used for adjusting a focus or a zoom of a lens.

10. The digital image capturing device as claimed in claim 8, wherein the operational status of the motor comprises clockwise rotation, anti-clockwise rotation, or change of rotation rate.

11. The digital image capturing device as claimed in claim 8, further comprising a microphone used for recording a simulated sound of the motor to obtain the simulated sound wave.

12. The digital image capturing device as claimed in claim 11, wherein the microphone is further used for recording the sound of the dynamic film.

13. The digital image capturing device as claimed in claim 8, wherein the obtained simulated sound wave is a non-compressed sound wave.

14. The digital image capturing device as claimed in claim 8, wherein the obtained simulated sound wave is a sectioned sound wave.

15. The digital image capturing device as claimed in claim 14, wherein the sectioned sound wave further comprising a volume altitude and a sound frequency.
